(19) United States
(12) Patent Application Publication
(10) Pub. No.: US 2026/0067257 A1
(43) Pub. Date: Mar. 5, 2026

(54) SECURE TRANSFER OF PERSONALLY IDENTIFIABLE INFORMATION FOR VIRTUAL ASSET SERVICE PROVIDERS

(71) Applicant: Coinbase, Inc., Oakland, CA (US)

(72) Inventors: Khiem Tran, Coquitlam (CA); Ranjeet Singh Suri, Richmond (CA)

(21) Appl. No.: 18/826,157

(22) Filed: Sep. 5, 2024

(51) Int. Cl. H04L 9/40; G06F 21/62

(52) U.S. Cl. CPC H04L 63/0428; G06F 21/6245

(57) ABSTRACT

Methods, systems, and devices for data management are described. A personally identifiable information (PII) transmission service may receive, from a first virtual asset service provider (VASP), a request to securely transfer PII of a first user of the first VASP to a second VASP, where the request includes the PII and is received based on a requested blockchain transfer of an amount of a crypto token from a first blockchain address of the first user and managed by the first VASP to a second blockchain address managed by the second VASP. The PII transmission service may encrypt the PII after receiving the request and store the encrypted PII of the first user at a database associated with the PII transmission service. The PII transmission service may securely transmit an indication of the encrypted PII stored at the database of the PII transmission service and accessible by the second VASP.

### FIELD OF TECHNOLOGY

The present disclosure relates generally to data management, including techniques for secure transfer of personally identifiable information (PII) for virtual asset service providers (VASPs).

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support secure transfer of personally identifiable information (PII) for virtual asset service providers (VASPs) in accordance with aspects of the present disclosure.

FIGS. 3 and 4 show examples of process flows that support secure transfer of PII for VASPs in accordance with aspects of the present disclosure.

FIG. 5 shows a block diagram of an apparatus that supports secure transfer of PII for VASPs in accordance with aspects of the present disclosure.

FIG. 6 shows a block diagram of a secure PII transfer manager that supports secure transfer of PII for VASPs in accordance with aspects of the present disclosure.

FIG. 7 shows a diagram of a system including a device that supports secure transfer of PII for VASPs in accordance with aspects of the present disclosure.

FIG. 8 shows a block diagram of an apparatus that supports secure transfer of PII for VASPs in accordance with aspects of the present disclosure.

FIG. 9 shows a block diagram of a secure PII transfer manager that supports secure transfer of PII for VASPs in accordance with aspects of the present disclosure.

FIG. 10 shows a diagram of a system including a device that supports secure transfer of PII for VASPs in accordance with aspects of the present disclosure.

FIGS. 11 through 14 show flowcharts illustrating methods that support secure transfer of PII for VASPs in accordance with aspects of the present disclosure.

### DETAILED DESCRIPTION

Virtual asset service providers (VASPs), such as entities that execute exchanges between virtual assets (e.g., cryptocurrencies), including banks, custodial services, exchanges, financial services, or the like, may be subject to one or more regulatory requirements to execute virtual asset services, such as exchanges. For example, VASPs may be subject to a travel rule in which specifies that information associated with an originator of a transaction and a recipient or beneficiary of a transaction is to be identified. Such information may be referred to herein as personally identifiable information (PII). VASPs may be subject to the travel rule in examples in which an amount of a virtual asset involved in an exchange or transaction exceeds a threshold. The information required to satisfy the travel rule, the threshold for which the travel rule is applicable, or both may vary based on a geographic location. For example, VASPs in a first geographic location may provide a name and blockchain address of an originator and a VASP of a beneficiary of a transaction to satisfy the travel rule, while VASPs in a second geographic location may provide names and blockchain addresses for both the originator and the beneficiary of the transaction to satisfy the travel rule. In some cases, a transaction may fail or be reversed in examples in which the travel rule is not satisfied. That is, if the originator, the beneficiary, or both of a transaction fail to provide PII to satisfy the travel rule, the transaction may fail (e.g., may not be broadcast) or be reversed. Additionally, some travel rule solutions may not support exchange of PII between VASPs of different travel rule solutions. For example, different VASPs may establish secure connections with one-another to securely exchange information, but configuring systems and resources for establishing such connections may be complex given different configurations of the different VASP systems.

As described herein, a PII transmission service may support secure transfer of PII for VASPs of the PII transmission service to a different VASP. For example, the PII transmission service may communicate, on behalf of a first VASP, with a second VASP to provide or obtain PII. The PII transmission service may receive requests to transfer PII, requests to receive PII, or both from the first VASP. In examples in which the PII transmission service receives a request to transfer PII, the PII transmission service may securely store the PII on a database and provide an indication of the encrypted PII accessible by the second VASP. In some examples, the indication may be a link accessible by the second VASP such that the second VASP may satisfy a travel rule. In other words, the second VASP may access the PII, where the PII includes information associated with the originator of the transaction. In examples in which the PII transmission service receives a request to receive PII, the PII transmission service may generate a link where the second VASP may input PII. After receiving the PII from the second VASP, the PII transmission service may securely store the PII on a database. The PII transmission service and the database, as described herein, may refer to instance of the PII transmission service on a computing device associated with the first VASP. For example, the database may store information associated with transactions involving a first blockchain address of users, including PII of the users and one or more other users having second blockchain addresses that were involved in a blockchain transaction with the first blockchain address.

By providing the link to the second VASP to securely access PII of the user of the first VASP or to securely input PII of the user of the second VASP, techniques described herein may support exchange of PII between VASPs of different PII transmission services, VASPs unassociated with PII transmission services, or both. For example, the user of the second VASP may access and/or provide PII to satisfy a travel rule via the links generated by the PII transmission service. Additionally, by storing the PII on a database of the PII transmission service (e.g., rather than a centralized database accessible by multiple VASPs) techniques described herein support secure storage of PII. In other words, the database of the PII transmission service may have an improved level of security relative to a centralized database storing data of multiple VASPs.

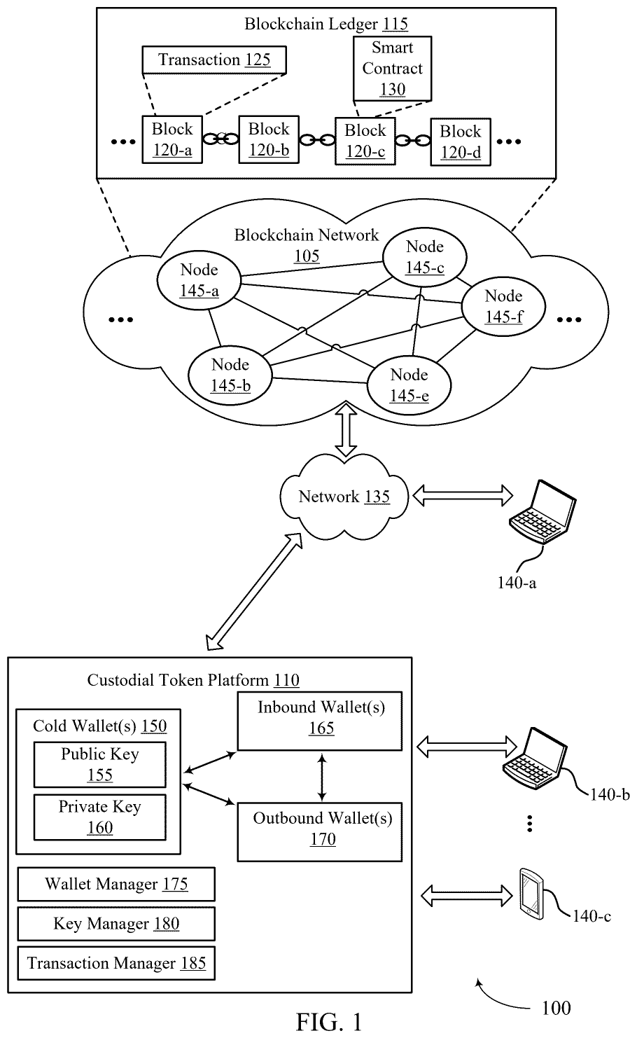

FIG. 1 illustrates an example of a computing environment 100 that supports secure transfer of PII for VASPs in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some cases, the custodial token platform 110, which may be an example of a first VASP, may execute a blockchain transfer of an amount of a crypto token from a first blockchain address of a first user of the custodial token platform to a second blockchain address of a second VASP. In other words, the custodial token platform 110 may broadcast one or more messages to the blockchain network 105, where the one or more messages are configured to transfer the amount of the crypto token from the first blockchain address to the second blockchain address. In some cases, the blockchain transfer may be executed based on input by a user. For example, the user may access the account to transfer the amount from a blockchain address associated with the user account to the second blockchain address, which may be a blockchain address associated with the user at the second VASP or may be a blockchain address associated with a second user at the second VASP. To satisfy a travel rule, the custodial token platform 110 may send PII of the first user directly to the second VASP and/or obtain PII of a second user of the second blockchain address via a blockchain lookup service. For example, the custodial token platform 110 may request PII of the second user of the second blockchain address (e.g., periodically, repeatedly, etc.) from the blockchain lookup service until the PII is available at the blockchain lookup service (e.g., until the second VASP inputs the PII to the blockchain lookup service).

In such cases, the exchange of PII between the custodial token platform 110, the second VASP, and the blockchain lookup service may be via encrypted and secure connections. For example, the custodial token platform 110, the second VASP, and the blockchain lookup service may exchange data (e.g., PII) via a mutual transport layer security (mTLS) connection. Additionally, or alternatively, the custodial token platform 110, the second VASP, and the blockchain lookup service may encrypt data sent via the secure connection such that the data may be decrypted by the intended recipient. However, in order to exchange the PII and satisfy the travel rule, the custodial token platform 110 and the second VASP may each access the blockchain lookup service. That is, the custodial token platform 110 and the second VASP may satisfy the travel rule when using a same travel rule solution (e.g., the blockchain lookup service). As such, in examples in which the second VASP does not support the blockchain lookup service, the custodial token platform 110 may not satisfy the travel rule and/or execute blockchain transfers involving the second VASP. Additionally, the blockchain lookup service may be centralized (and thus subject to attack) and establishing connections between the two VASPs may require complex configuration at both of the VASPs.

As described herein, a PII transmission service may support secure transfer of PII for VASPs of the PII transmission service or of a different PII transmission service. For example, the PII transmission service may communicate, on behalf of the custodial token platform 110, with a second VASP to provide or obtain PII. The PII transmission service may receive requests to transfer PII, requests to receive PII, or both from the custodial token platform 110. In examples in which the PII transmission service receives a request to transfer PII, the PII transmission service may securely store the PII on a database and provide an indication of the encrypted PII accessible by the second VASP. In some examples, the indication may be a link accessible by the second VASP such that the second VASP may satisfy a travel rule. In other words, the second VASP may access the PII, where the PII includes information associated with the originator of the transaction. In examples in which the PII transmission service receives a request to receive PII, the PII transmission service may generate a link where the second VASP may input PII. After receiving the PII from the second VASP, the PII transmission service may securely store the PII on a database. The PII transmission service and the database, as described herein, may refer to instance of the PII transmission service on a computing device 140 of a user of the custodial token platform 110 and a database of the user. For example, the database may store information associated with transactions involving a first blockchain address of the user, including PII of the user and one or more other users having second blockchain addresses that were involved in a blockchain transaction with the first blockchain address.

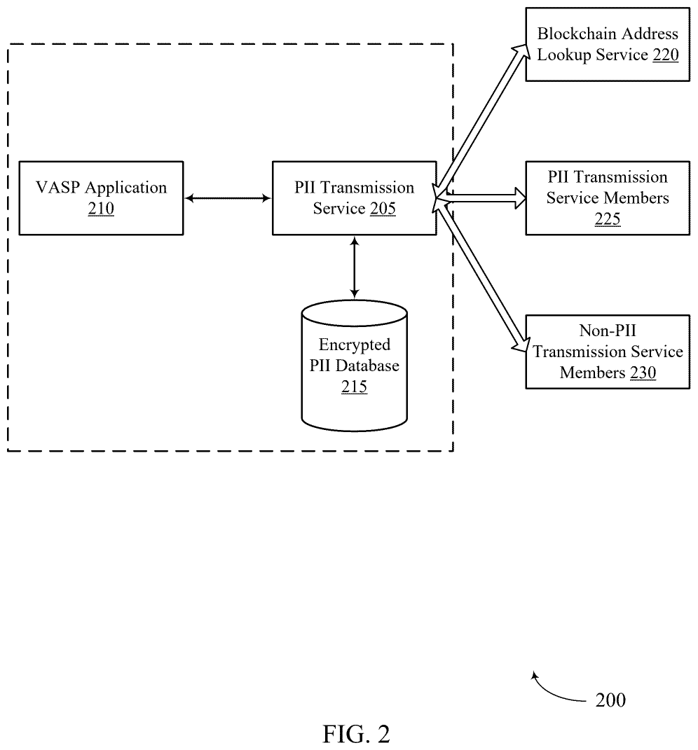

FIG. 2 shows an example of a computing environment 200 that supports secure transfer of PII for VASPs in accordance with aspects of the present disclosure. The computing environment 200 may include a VASP application 210, which may be an example of an application supported by or otherwise associated with the custodial token platform 110 as described with reference to FIG. 1. For example, the custodial token platform 110 may be an example of a VASP. Additionally, the computing environment 200 may include a PII transmission service 205 and an encrypted PII database 215, which may be associated with the VASP application. For example, the PII transmission service 205 and the encrypted PII database 215 may be components or services of the custodial token platform 110.

The PII transmission service 205 may be an example of an instance of the PII transmission service 205 on a computing device or system of a first user of the VASP application 210. For example, the PII transmission service 205 may be installed or otherwise included on the computing device, such as the computing device 140 as described with reference to FIG. 1. In other words, the VASP application 210 may host the PII transmission service 205 on an infrastructure of the VASP (e.g., on the computing device). Additionally, or alternatively, the encrypted PII database 215 may be associated with the VASP application 210 (e.g., a first VASP). That is, the encrypted PII database 215 may include encrypted PII associated with blockchain transfers involving a first blockchain address of the first user (and other users that send transactions via the VASP). For example, the encrypted PII may include PII of the first user and PII of one or more second users associated with one or more second blockchain addresses which were involved in blockchain transfers with the first blockchain address. In other words, the encrypted PII database 215 may include information satisfying a travel rule.

The PII transmission service 205 may perform one or more operations based on receiving application programming interface (API) calls from the VASP application 210. The one or more operations may include encrypting messages, communicating via a secure connection, encrypting and storing PII, generating a list of VASPs, registering and querying ownerships of blockchain addresses, sending PII, requesting PII, requesting a return of an amount of a crypto token, or the like. For example, the PII transmission service 205 may encrypt messages and communicate via a secure connection (e.g., an mTLS connection) with the blockchain address lookup service 220, PII transmission service members 225, and non-PII transmission service members 230. Additionally, or alternatively, the PII transmission service 205 may encrypt and store PII at the encrypted PII database 215.

An implementation complexity at the VASP application 210 may be reduced based on transmission of API calls to perform operations at the PII transmission service 205 that are unassociated with whether an originator or beneficiary VASP (e.g., a second VASP) of a blockchain transfer is associated with the PII transmission service 205. That is, the PII transmission service 205 communicates with the blockchain address lookup service 220, the PII transmission service members 225, and the non-PII transmission service members 230 on behalf of the VASP application 210, which may reduce an implementation complexity at the VASP application 210.

The PII transmission service 205 may include one or more peer-to-peer (P2P) endpoints. For example, the P2P endpoints may receive PII, respond to requests for PII, respond to requests for returns of amounts of crypto tokens, or the like. The VASP application 210 may configure PII to be encrypted and stored at the encrypted PII database 215, forwarded to a P2P endpoint (e.g., an internal PII request endpoint), forwarded to a message queue, or any combination thereof. In some examples, the PII transmission service 205 may include a user interface. For example, the PII transmission service 205 may display, via a user interface (e.g., on a computing device of the first user), one or more options to download or upload PII. In other words, the user interface may include options to input and/or confirm transmission of PII to another VASP, options to request PII from another VASP, or both.

The VASP application 210 may request a list of VASPs from the PII transmission service 205. For example, the VASP application 210 may request the list of VASPs by transmitting an API call to the PII transmission service 205 (e.g., calling an API of the PII transmission service 205). The list of VASPs may include first VASPs which are PII transmission service members 225, second VASPs which are non-PII transmission service members 230, or both. The PII transmission service 205 may obtain the first VASPs which are PII transmission service members 225 via the blockchain address lookup service 220. Additionally, or alternatively, the PII transmission service 205 may obtain the second VASPs which are non-PII transmission service members 230 via a database table, a configuration file, or the like. The second VASPs may, in some cases, be VASPs which were involved in a blockchain transfer with the VASP application 210 and, thus, are included in the encrypted PII database 215. The list of VASPs may include, for each VASP, a universal unique identifier (UUID), a name, and a blockchain network.

In some examples, securely transferring the PII via the PII transmission service 205 may involve an authentication and/or authorization procedure. For example, the first user of the VASP application 210 may connect with an authentication server after completing an authentication procedure before providing or obtaining PII. Additionally, or alternatively, the second user of another VASP involved in the exchange of PII may complete the authentication and/or authorization procedure. That is, after receiving an indication of PII of the first user or receiving an indication to input PII, the second user may be prompted to create an account with the PII transmission service 205 and complete the authentication and/or authorization procedure. The authentication procedure may involve multi-factor authentication, such as two-factor authentication. Additionally, or alternatively, completion of the authentication procedure may involve provision of a token, such as a JavaScript Object Notation (JSON) web token (JWT), which may be associated with a browser (e.g., as a browser cookie) of a computing device of the user.

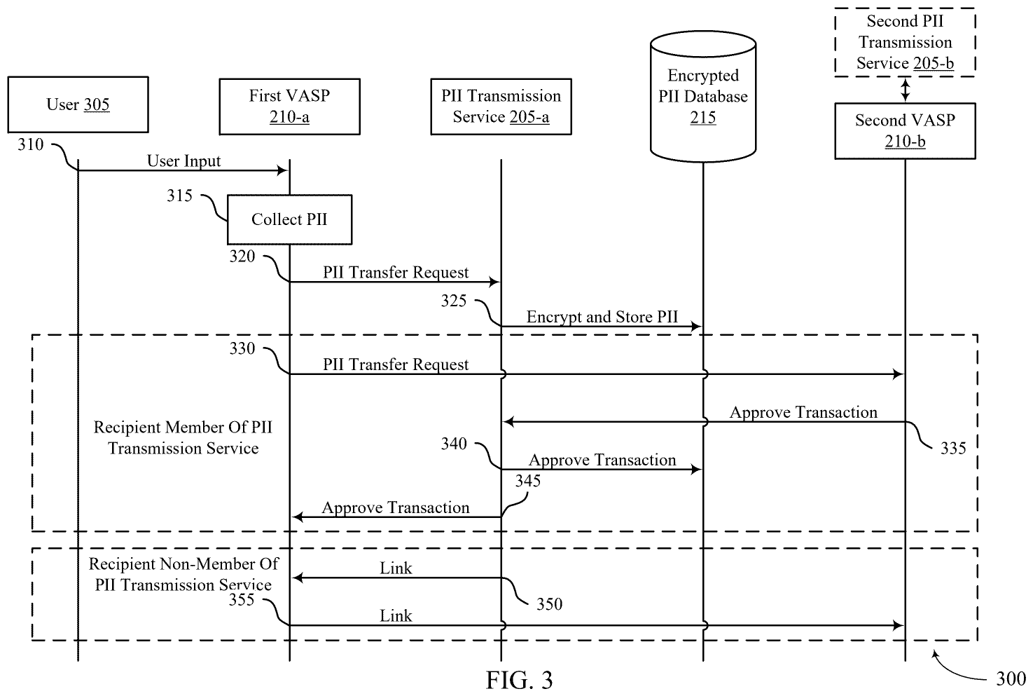

The PII transmission service 205 may facilitate the secure transfer of PII for execution of blockchain transfers by the VASP application 210 to satisfy the travel rule. The PII transmission service 205 may support secure transfer of PII from PII transmission service members 225, non-PII transmission service members 230, or both. For example, the PII transmission service 205 may, in examples in which the parties involved in the secure transfer of PII (e.g., the originator and the beneficiary) are both PII transmission service members 225 (e.g., members of the same PII transmission service or different PII transmission services), establish a secure connection by which the PII may be transferred. That is, the PII transmission service 205 may establish a secure connection with another PII transmission service of a second VASP, such as the second PII transmission service 205-b as described with reference to FIG. 3. Alternatively, in examples in which a party involved in the secure transfer of PII is a non-PII transmission service member 230, the PII transmission service 205 may generate and provide a link to securely input or obtain PII. That is, the PII transmission service 205 may provide a link to a first VASP of a first user, where the first VASP may forward the link to the second VASP of the second user. The second user, via the link, may provide PII, access PII, or both.

FIG. 3 shows an example of a process flow 300 that supports secure transfer of PII for VASPs in accordance with aspects of the present disclosure. In some examples, the process flow 300 may implement or be implemented by the computing environment 100, the computing environment 200, or both. For example, the process flow 300 may include a first VASP 210-a, a PII transmission service 205-a, an encrypted PII database 215, and a second VASP 210-b, which may be examples of the corresponding devices or systems as described with reference to FIG. 2.

Alternative examples of the following may be implemented, where some operations are performed in a different order than described or are not performed at all. In some cases, operations may include additional features not mentioned below, or further operations may be added. Although the user 305, the first VASP 210-a, the PII transmission service 205, the encrypted PII database 215, and the second VASP 210-b are shown performing the operations of the process flow 300, some aspects of some operations may also be performed by one or more other components.

The process flow 300 may illustrate and describe an example in which the PII transmission service 205-a securely transmits PII of the user 305 of the first VASP 210-a associated with the PII transmission service 205-a to a second VASP 210-b. The second VASP 210-b may, in some examples, be associated with the PII transmission service 205-a or, in some other examples, be associated with a second PII transmission service 205-b.

At 310, the user 305 may provide a user input to the first VASP 210-a. The user input may include an indication of a beneficiary of a blockchain transfer. In other words, the input may include an indication of a second blockchain address and the second VASP 210-b, where the second blockchain address is to receive an amount of a crypto token from a first blockchain address of the user 305. That is, the first VASP 210-a may receive, based on a transfer of an amount of a crypto token from the first blockchain address of the user 305 and managed by the first VASP 210-a to a second blockchain address managed by the second VASP 210-b, a user input indicative of the second VASP 210-b and the second blockchain address. In some examples, the user 305 may select the beneficiary based on a list provided by the PII transmission service 205-a. That is, prior to 310, the first VASP 210-a may transmit one or more API calls to the PII transmission service 205-a to obtain a list of VASPs, and the user 305 may select the beneficiary from the list of VASPs via a user interface of the first VASP 210-a (e.g., on a computing device). In some examples, the first VASP 210-a may be configured to prompt for the information, such as the second VASP 210-b and/or the PII, when the user attempts to transfer an amount that satisfies a travel rule.

At 315, the first VASP 210-a may collect PII. For example, the first VASP 210-a may collect PII associated with the user 305 (e.g., the originator) and the beneficiary. That is, the first VASP 210-a may collect PII associated with a second user of the second blockchain address of the second VASP 210-b. To collect the PII associated with the beneficiary, the first VASP 210-a may perform one or more of the operations at 320 through 355. Additionally, since the user 305 is a user of the first VASP 210-a, the first VASP 210-a may maintain a record of the user's PII and/or may collect the PII in response to the user attempting the transfer of the crypto token.

At 320, the first VASP 210-a may transmit a PII transfer request to the PII transmission service 205-a. In other words, the first VASP 210-a may transmit, to the PII transmission service 205-a and after receiving the user input at 310, a request to securely transfer PII of the user 305 of the first VASP 210-a with the second VASP 210-b. The PII transfer request may be referred to as a pre-transaction PII request. That is, the first VASP 210-a may transmit the PII transfer request prior to execution of the blockchain transfer of the amount of the crypto token from the first blockchain address of the user 305 to the second blockchain address of the second VASP 210-b. In some examples, the request may be transmitted via one or more API calls that invoke one or more functions at the PII transmission service 205-a configured to encrypt the PII, store the PII, securely transmit the indication, or any combination thereof.

The PII transfer request may include or indicate PII of the user 305 to be securely shared with the second VASP 210-b. The provision of PII of the user 305 to the second VASP 210-b may satisfy a condition, such as a travel rule. For example, the request to securely transfer the PII may be based on a geographic region of the user 305 (e.g., comply with a travel rule of the geographic region). In some examples, the PII may include the PII information indicative of the user 305 that is an owner of the first blockchain address. As an example, the PII may include a name, account number, address, or any combination thereof.

At 325, the PII transmission service 205-a may encrypt and store PII at the encrypted PII database 215. In other words, the PII transmission service 205-a may encrypt the PII after receiving the request at 320 and store the encrypted PII of the user 305 at a database associated with the PII transmission service, such as at the encrypted PII database 215. That is, the PII transmission service 205-a may encrypt and store PII of the user 305 provided by the first VASP 210-a in the PII transfer request at 320.

After encrypting and storing the PII at the encrypted PII database 215, the PII transmission service 205-a may securely transmit an indication of the encrypted PII stored at the encrypted PII database 215 accessible by the second VASP 210-b. In examples in which the second VASP 210-b is associated with the PII transmission service 205-a, the first VASP 210-a, the PII transmission service 205-a, the encrypted PII database 215, and the second VASP 210-b may perform the operations at 330 through 345. For example, at 330, the first VASP 210-a may transmit a PII transfer request to the second VASP 210-b. The PII transfer request may be referred to as a pre-transaction request.

At 335, the second VASP 210-b may transmit an approve transaction request. For example, the second VASP 210-b may approve the transaction based on receiving the PII transfer request at 330. At 340, the PII transmission service 205-a may transmit an approve transaction request to the encrypted PII database 215. For example, the PII transmission service 205-a may transmit the approve transaction request based on receiving the approve transaction request from the second VASP 210-b at 335. At 345, the PII transmission service 205-a may confirm the transaction with the first VASP 210-a. That is, the PII transmission service 205-a may confirm completion of the transaction after receiving the approve transaction request from the second VASP 210-b.

In examples in which the second VASP 210-b is associated with the PII transmission service 205-a or the second PII transmission service 205-b, securely transmitting the indication of the encrypted PII stored at the encrypted PII database 215 may include establishing, with a second instance of the PII transmission service 205-a or with the second PII transmission service 205-b associated with the second VASP 210-b, a secure connection and transferring, via the secure connection, the PII of the user 305 to the second instance of the PII transmission service 205-a or the second PII transmission service 205-b associated with the second VASP 210-b. In some examples, the secure connection may be established based on the first VASP 210-a and the second VASP 210-b being associated with the PII transmission service 205-a (e.g., each VASP application 210 executes a respective instance of the PII transmission service 205).

In examples in which the second VASP 210-b is unassociated with a PII transmission service, (e.g., the second VASP 210-b does not execute an instance of the PII transmission service), the first VASP 210-a, the PII transmission service 205-a, and the second VASP 210-b may perform the operations at 350 and 355. For example, at 350, the PII transmission service 205-a may transmit a link to the first VASP 210-a. That is, the PII transmission service 205-a may transmit, to the first VASP 210-a, a link to the encrypted PII stored at the encrypted PII database 215 of the PII transmission service 205-a and accessible by the second VASP 210-b. In some examples, the link may be transmitted based on the second VASP 210-b not being associated with the PII transmission service 205-a and/or the PII transmission service 205-b.

The PII transmission service 205-a may generate the link (e.g., a secure link) via a secure token, such as a random sequence. In some examples, transmitting the link to the first VASP 210-a may include transmitting the link (e.g., with the secure token) to an email address associated with the first VASP 210-a. The link may be associated with an expiry time (e.g., 24 hours). Additionally, or alternatively, the link may be accessible a threshold quantity of times, such as one time. That is, the second VASP 210-b may access the link once to obtain the PII of the user 305, but not thereafter. The PII transmission service 205-a may generate an updated link (e.g., refresh the link) by generating a new token and sending the new token to the email address of the first VASP 210-a.

At 355, the first VASP 210-a may transmit the link to the second VASP 210-b.

That is, the first VASP 210-a may forward the link received at 350 to the second VASP 210-b. In some examples, the requested blockchain transfer of the amount of the crypto token (e.g., requested via the user input at 310) may be executed via a blockchain network based on securely transmitting (e.g., at 350 and/or 355) the indication (e.g., directly or indirectly, such as via the link) of the encrypted PII.

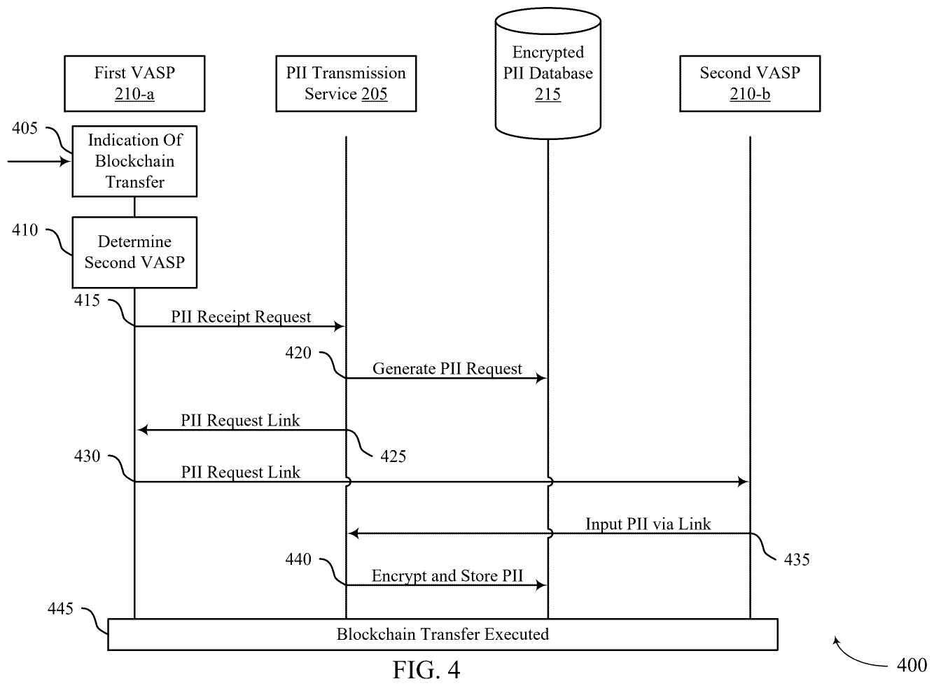

FIG. 4 shows an example of a process flow 400 that supports secure transfer of PII for VASPs in accordance with aspects of the present disclosure. In some examples, the process flow 400 may implement or be implemented by the computing environment 100, the computing environment 200, or both. For example, the process flow 400 may include a first VASP 210-a, a PII transmission service 205, an encrypted PII database 215, and a second VASP 210-b, which may be examples of the corresponding devices as described with reference to FIG. 2.

Alternative examples of the following may be implemented, where some operations are performed in a different order than described or are not performed at all. In some cases, operations may include additional features not mentioned below, or further operations may be added. Although the first VASP 210-a, the PII transmission service 205, the encrypted PII database 215, and the second VASP 210-b are shown performing the operations of the process flow 400, some aspects of some operations may also be performed by one or more other components.

The process flow 400 may illustrate and describe an example in which the PII transmission service 205 securely receives PII of a user of the second VASP 210-b. The second VASP 210-b may, in some examples, be associated with a second PII transmission service different than the PII transmission service 205.

At 405, the first VASP 210-a may receive an indication of a blockchain transfer. For example, the first VASP 210-a may receive an indication of a requested blockchain transfer of an amount of a crypto token from a first blockchain address managed by the first VASP 210-a to a second blockchain address. In other words, the first VASP 210-a may identify an incoming transaction, where the transaction is unassociated with PII of at least an originator of the transaction (e.g., a sender).

At 410, the first VASP 210-a may determine the second VASP 210-b. That is, the first VASP 210-a may identify the second VASP 210-b managing the second blockchain address associated with the blockchain transfer identified at 405. In some examples, the first VASP 210-a may identify the second VASP 210-b (e.g., the originating VASP) based on blockchain analysis.

At 415, the first VASP 210-a may transmit a PII receipt request to the PII transmission service 205. For example, the first VASP 210-a may transmit, to the PII transmission service 205, a request to securely receive PII from the second VASP 210-b. The request may be received based on a requested blockchain transfer of the amount of the crypto token to the first blockchain address managed by the first VASP 210-a and from the second blockchain address managed by the second VASP 210-b. In some examples, the first VASP 210-a may transmit one or more API calls to the PII transmission service 205 configured to invoke one or more functions associated with receiving PII. For example, the one or more API calls may be configured to generate a PII request, transmit a PII request link, and receive uploaded PII from the second VASP 210-b.

At 420, the PII transmission service 205 may generate a PII request via the encrypted PII database 215. For example, the PII transmission service 205 may generate a request in the encrypted PII database 215 and generate a link to upload PII to the encrypted PII database 215. The PII transmission service 205-a may generate the link (e.g., a secure link) via a secure token, such as a random sequence. In some examples, transmitting the link to the first VASP 210-a may include transmitting the link (e.g., with the secure token) to an email address associated with the first VASP 210-a. The link may be associated with an expiry time (e.g., 24 hours). Additionally, or alternatively, the link may be accessible a threshold quantity of times, such as one time. That is, the second VASP 210-b may access the link once to input the PII of the user of the second blockchain address, but not thereafter. The PII transmission service 205-a may generate an updated link (e.g., refresh the link) by generating a new token and sending the new token to the email address of the first VASP 210-a.

At 425, the PII transmission service 205 may transmit a PII request link to the first VASP 210-a. For example, the PII transmission service 205 may transmit, to the first VASP 210-a, a link to the PII transmission service 205 and accessible by the second VASP 210-b to input the PII. At 430, the first VASP 210-a may transmit the PII request link to the second VASP 210-b. That is, the first VASP 210-a may forward the PII request link to the second VASP 210-b.

At 435, the second VASP 210-b may input PII via the link to the PII transmission service 205. That is, the PII transmission service 205 may receive, after transmitting the link at 425, PII from the second VASP 210-b. The PII may include a name, account number, address, a customer identification number, a birth certificate number, a passport number, a national identifier card number, a date, a place of birth, or any combination thereof. After receiving the PII, at 440, the PII transmission service 205 may encrypt and store the PII. In other words, the PII transmission service 205 may encrypt the PII from the second VASP 210-b after receiving the PII via the link and store the encrypted PII from the second VASP 210-b at the encrypted PII database 215 associated with the PII transmission service 205 (e.g., the instance of the PII transmission service 205 associated with the first VASP 210-a).

At 445, after the second VASP 210-b inputs the PII to the PII transmission service 205, the blockchain transfer of the amount of the crypto token from the first blockchain address managed by the first VASP 210-a to the second blockchain address managed by the second VASP 210-b may be executed. That is, the blockchain transfer may be executed (e.g., via a blockchain network) based on or after the PII of the recipient of the blockchain transfer is provided. In other words, the blockchain transfer may be executed based on the travel rule being satisfied.

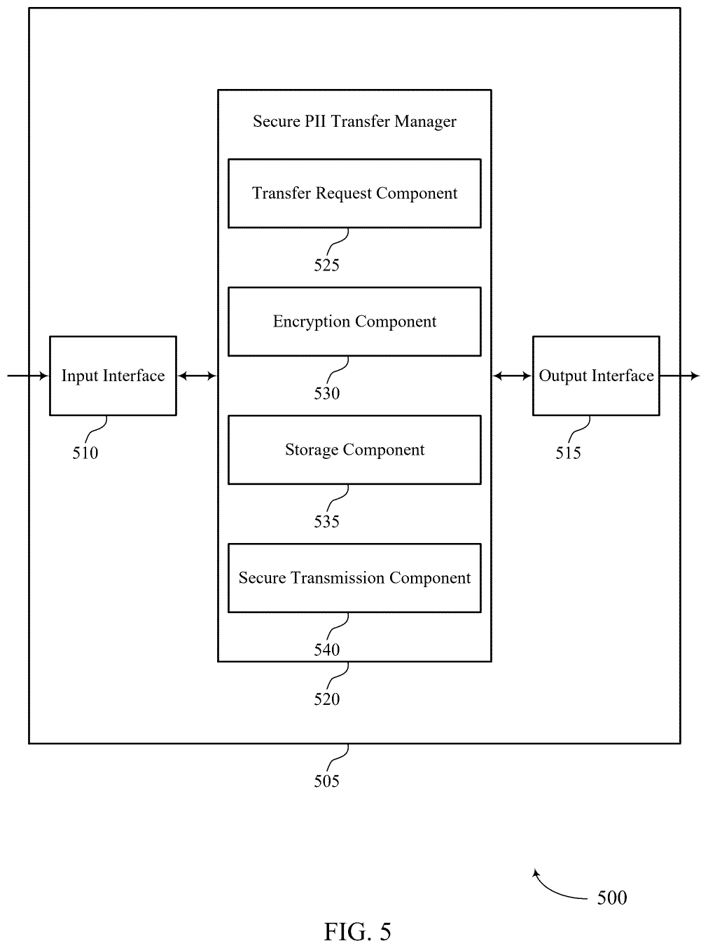

FIG. 5 shows a block diagram 500 of a system 505 that supports secure transfer of PII for VASPs in accordance with aspects of the present disclosure. The system 505 may include an input interface 510, an output interface 515, and a secure PII transfer manager 520. The system 505, or one or more components of the system 505 (e.g., the input interface 510, the output interface 515, the secure PII transfer manager 520), may include at least one processor, which may be coupled with at least one memory, to support the described techniques. Each of these components may communicate, directly or indirectly, with one another (e.g., via one or more buses, communications links, communications interfaces, or any combination thereof). The system 505 may be an example of a PII transmission service, such as the PII transmission service 205 as described with reference to FIGS. 2-4.

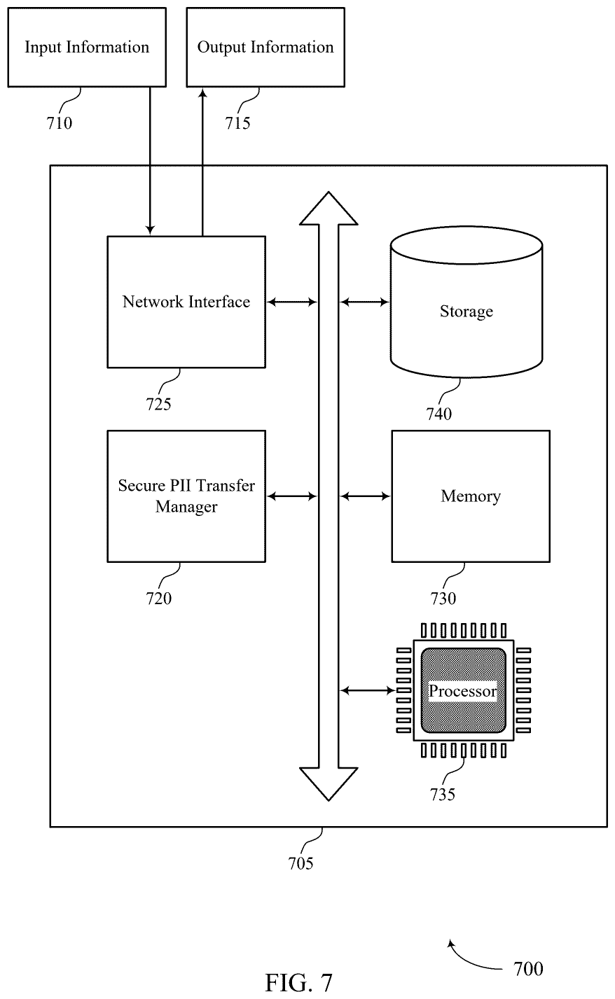

The input interface 510 may manage input signaling for the system 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the secure PII transfer manager 520 to support secure transfer of PII for VASPs. In some cases, the input interface 510 may be a component of a network interface 725 as described with reference to FIG. 7.

The output interface 515 may manage output signaling for the system 505. For example, the output interface 515 may receive signaling from other components of the system 505, such as the secure PII transfer manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the secure PII transfer manager 520 may include a transfer request component 525, an encryption component 530, a storage component 535, a secure transmission component 540, or any combination thereof. In some examples, the secure PII transfer manager 520, or various components thereof, may be configured to perform various operations (e.g., receiving, monitoring, transmitting) using or otherwise in cooperation with the input interface 510, the output interface 515, or both. For example, the secure PII transfer manager 520 may receive information from the input interface 510, send information to the output interface 515, or be integrated in combination with the input interface 510, the output interface 515, or both to receive information, transmit information, or perform various other operations as described herein.

The secure PII transfer manager 520 may support secure exchange of PII (PII) in accordance with examples as disclosed herein. The transfer request component 525 may be configured as or otherwise support a means for receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP. The encryption component 530 may be configured as or otherwise support a means for encrypting the PII after receiving the request. The storage component 535 may be configured as or otherwise support a means for storing the encrypted PII of the first user at a database associated with the PII transmission service. The secure transmission component 540 may be configured as or otherwise support a means for securely transmitting an indication of the encrypted PII stored at the database of the PII transmission service and accessible by the second VASP.

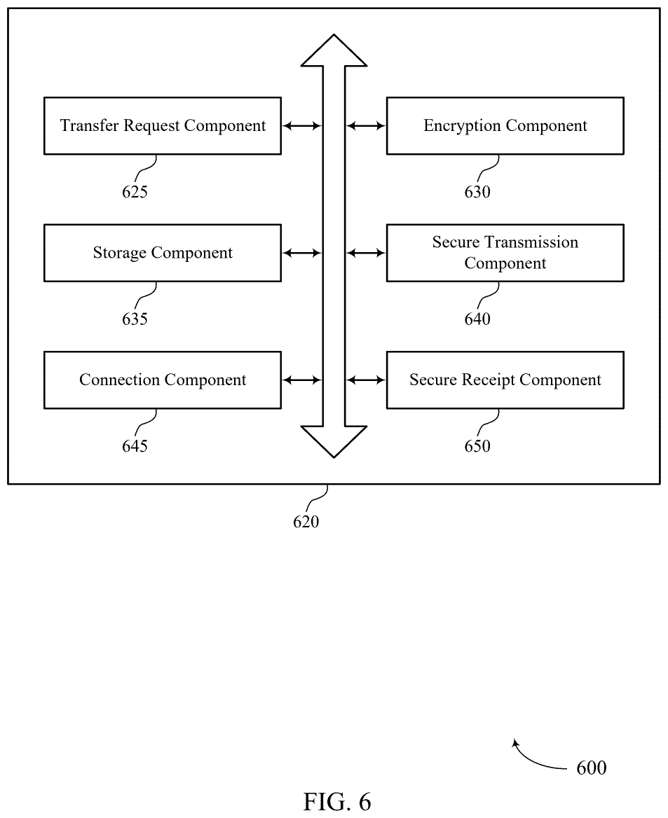

FIG. 6 shows a block diagram 600 of a secure PII transfer manager 620 that supports secure transfer of PII for VASPs in accordance with aspects of the present disclosure. The secure PII transfer manager 620 may be an example of aspects of a secure PII transfer manager or a secure PII transfer manager 520, or both, as described herein. The secure PII transfer manager 620, or various components thereof, may be an example of means for performing various aspects of secure transfer of PII for VASPs as described herein. For example, the secure PII transfer manager 620 may include a transfer request component 625, an encryption component 630, a storage component 635, a secure transmission component 640, a connection component 645, a secure receipt component 650, or any combination thereof. Each of these components may communicate, directly or indirectly, with one another (e.g., via one or more buses, communications links, communications interfaces, or any combination thereof). The secure PII transfer manager 620 may be an example of or a component of a PII transmission service, such as the PII transmission service 205 as described with reference to FIGS. 2-4.

The secure PII transfer manager 620 may support secure exchange of PII (PII) in accordance with examples as disclosed herein. The transfer request component 625 may be configured as or otherwise support a means for receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP. The encryption component 630 may be configured as or otherwise support a means for encrypting the PII after receiving the request. The storage component 635 may be configured as or otherwise support a means for storing the encrypted PII of the first user at a database associated with the PII transmission service. The secure transmission component 640 may be configured as or otherwise support a means for securely transmitting an indication of the encrypted PII stored at the database of the PII transmission service and accessible by the second VASP.

In some examples, to support securely transmitting the indication of the encrypted PII, the connection component 645 may be configured as or otherwise support a means for establishing, with a second instance of the PII transmission service associated with the second VASP, a secure connection. In some examples, to support securely transmitting the indication of the encrypted PII, the secure transmission component 640 may be configured as or otherwise support a means for transferring, via the secure connection, the PII of the first user to the second instance of the PII transmission service associated with the second VASP.

In some examples, the secure connection is established based at least in part on the first VASP and the second VASP being associated with the PII transmission service.

In some examples, to support securely transmitting the indication of the encrypted PII, the secure transmission component 640 may be configured as or otherwise support a means for transmitting, to the first VASP, a link to the encrypted PII stored at the database of the PII transmission service and accessible by the second VASP.

In some examples, the link is transmitted based at least in part on the second VASP not being associated with the PII transmission service.

In some examples, the transfer request component 625 may be configured as or otherwise support a means for receiving, from the first VASP and at the PII transmission service, a second request to securely receive second PII from a third VASP, wherein the request is received based at least in part on a second requested blockchain transfer of a second amount of a second crypto token to a third blockchain address managed by the first VASP and from a fourth blockchain address managed by the third VASP. In some examples, the secure receipt component 650 may be configured as or otherwise support a means for transmitting, to the first VASP, a second link to the PII transmission service and accessible by the third VASP to input the second PII.

In some examples, the secure receipt component 650 may be configured as or otherwise support a means for receiving, after transmitting the second link, the second PII from the third VASP. In some examples, the encryption component 630 may be configured as or otherwise support a means for encrypting the second PII from the third VASP after receiving the second PII via the second link. In some examples, the storage component 635 may be configured as or otherwise support a means for storing the encrypted second PII from the third VASP at the database associated with the PII transmission service.

In some examples, the requested blockchain transfer of the amount of the crypto token is executed via a blockchain network based at least in part on securely transmitting the indication of the encrypted PII.

In some examples, the request to securely transfer the PII is based at least in part on a geographic region of the first user.

In some examples, the PII comprises information indicative of the first user that is an owner of the first blockchain address.

In some examples, to support receiving the request to securely transfer the PII of the first user, the transfer request component 625 may be configured as or otherwise support a means for receiving, from the first VASP, one or more API calls that invoke one or more functions at the PII transmission service configured to encrypt the PII, store the PII, securely transmit the indication, or any combination thereof.

FIG. 7 shows a diagram of a system 700 including a system 705 that supports secure transfer of PII for VASPs in accordance with aspects of the present disclosure. The system 705 may be an example of or include components of a system 505 as described herein. The system 705 may include components for secure transfer of PII, including components for transmitting and receiving communications, such as a secure PII transfer manager 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof). The system 705 may be an example of a PII transmission service, such as the PII transmission service 205 as described with reference to FIGS. 2-4.

The network interface 725 may enable the system 705 to exchange information (e.g., input information 710, output information 715, or both) with other systems or devices (not shown). For example, the network interface 725 may enable the system 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting secure transfer of PII for VASPs. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the system 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting secure transfer of PII for VASPs). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. The processor 735 may be an example of a single processor or multiple processors. For example, the system 705 may include one or more processors 735.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1.

The secure PII transfer manager 720 may support secure exchange of PII (PII) in accordance with examples as disclosed herein. For example, the secure PII transfer manager 720 may be configured as or otherwise support a means for receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP. The secure PII transfer manager 720 may be configured as or otherwise support a means for encrypting the PII after receiving the request. The secure PII transfer manager 720 may be configured as or otherwise support a means for storing the encrypted PII of the first user at a database associated with the PII transmission service. The secure PII transfer manager 720 may be configured as or otherwise support a means for securely transmitting an indication of the encrypted PII stored at the database of the PII transmission service and accessible by the second VASP.

By including or configuring the secure PII transfer manager 720 in accordance with examples as described herein, the system 705 may support techniques for improved user experience related to secure transfer of PII and improved capabilities related to performing blockchain transactions with a blockchain address of a different PII transmission service.

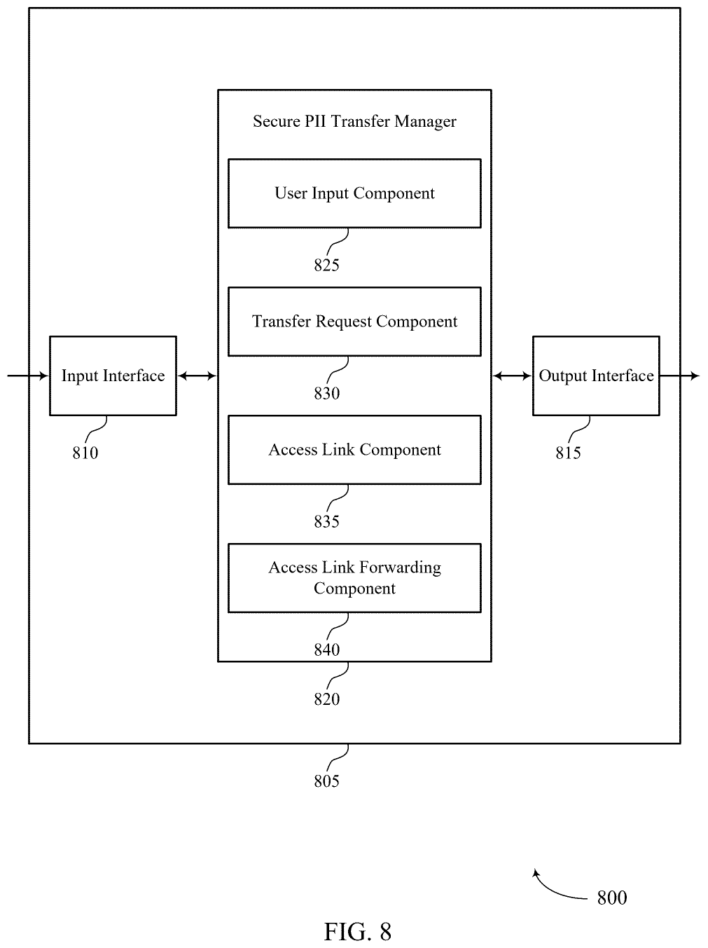

FIG. 8 shows a block diagram 800 of a system 805 that supports secure transfer of PII for VASPs in accordance with aspects of the present disclosure. The system 805 may include an input interface 810, an output interface 815, and a secure PII transfer manager 820. The system 805, or one or more components of the system 805 (e.g., the input interface 810, the output interface 815, the secure PII transfer manager 820), may include at least one processor, which may be coupled with at least one memory, to support the described techniques. Each of these components may communicate, directly or indirectly, with one another (e.g., via one or more buses, communications links, communications interfaces, or any combination thereof). The system 805 may be an example of or a component of a VASP, such as the first VASP 210-a as described with reference to FIGS. 3 and 4.

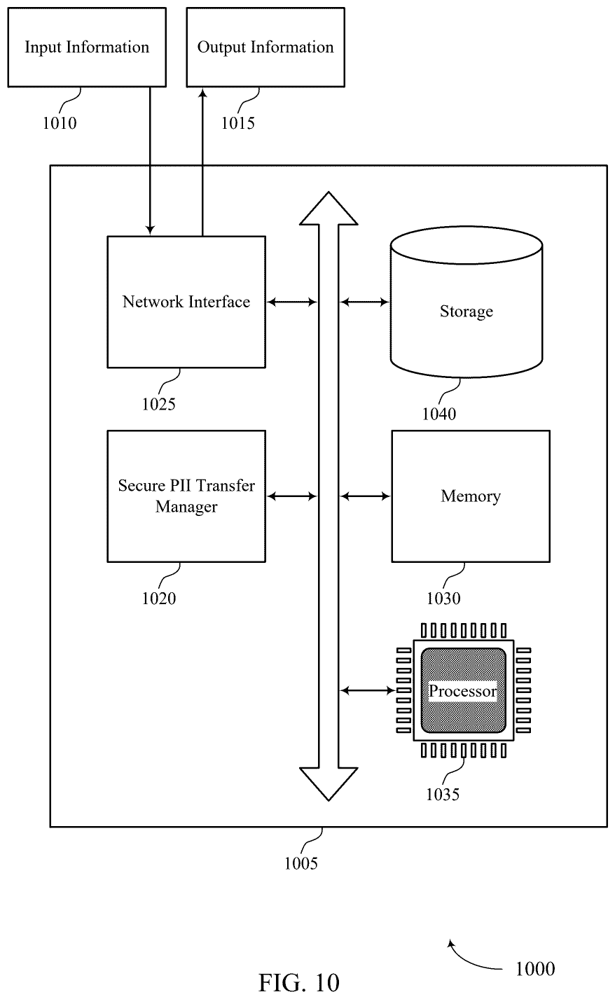

The input interface 810 may manage input signaling for the system 805. For example, the input interface 810 may receive input signaling (e.g., messages, packets, data, instructions, commands, transactions, or any other form of encoded information) from other systems or devices. The input interface 810 may send signaling corresponding to (e.g., representative of or otherwise based on) such input signaling to other components of the system 805 for processing. For example, the input interface 810 may transmit such corresponding signaling to the secure PII transfer manager 820 to support secure transfer of PII for VASPs. In some cases, the input interface 810 may be a component of a network interface 1025 as described with reference to FIG. 10.

The output interface 815 may manage output signaling for the system 805. For example, the output interface 815 may receive signaling from other components of the system 805, such as the secure PII transfer manager 820, and may transmit such output signaling corresponding to (e.g., representative of or otherwise based on) such signaling to other systems or devices. In some cases, the output interface 815 may be a component of a network interface 1025 as described with reference to FIG. 10.

For example, the secure PII transfer manager 820 may include a user input component 825, a transfer request component 830, an access link component 835, an access link forwarding component 840, or any combination thereof. In some examples, the secure PII transfer manager 820, or various components thereof, may be configured to perform various operations (e.g., receiving, monitoring, transmitting) using or otherwise in cooperation with the input interface 810, the output interface 815, or both. For example, the secure PII transfer manager 820 may receive information from the input interface 810, send information to the output interface 815, or be integrated in combination with the input interface 810, the output interface 815, or both to receive information, transmit information, or perform various other operations as described herein.

The secure PII transfer manager 820 may support secure exchange of PII (PII) in accordance with examples as disclosed herein. The user input component 825 may be configured as or otherwise support a means for receiving, based at least in part on a transfer of an amount of a crypto token from a first blockchain address of a first user and managed by a first VASP to a second blockchain address managed by a second VASP, a user input indicative of the second VASP and the second blockchain address. The transfer request component 830 may be configured as or otherwise support a means for transmitting, to a PII transmission service and after receiving the user input, a request to securely transfer PII of the first user of the first VASP with the second VASP. The access link component 835 may be configured as or otherwise support a means for receiving, from the PII transmission service, a link to access encrypted PII stored at a database of the PII transmission service and accessible by the second VASP. The access link forwarding component 840 may be configured as or otherwise support a means for transmitting the link to the second VASP.

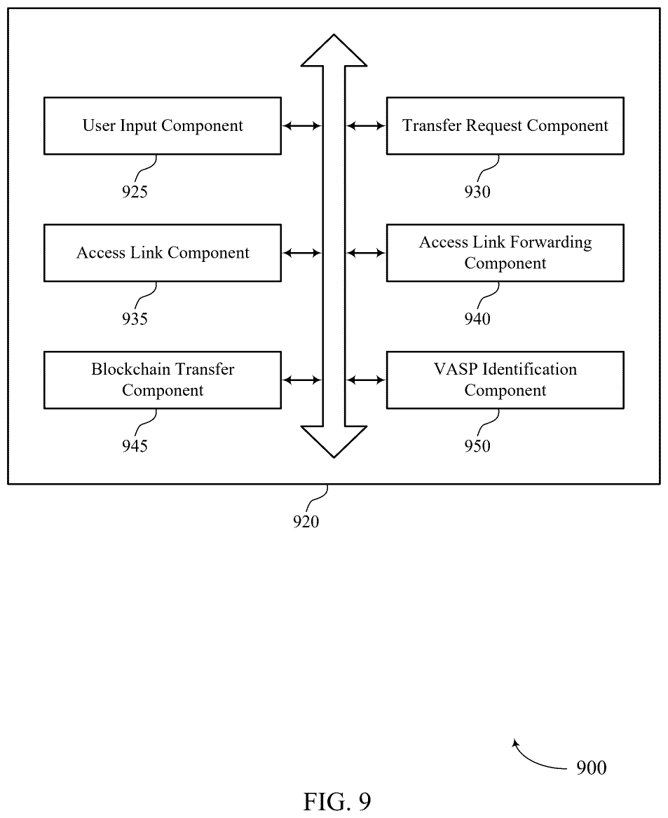

FIG. 9 shows a block diagram 900 of a secure PII transfer manager 920 that supports secure transfer of PII for VASPs in accordance with aspects of the present disclosure. The secure PII transfer manager 920 may be an example of aspects of a secure PII transfer manager or a secure PII transfer manager 820, or both, as described herein. The secure PII transfer manager 920, or various components thereof, may be an example of means for performing various aspects of secure transfer of PII for VASPs as described herein. For example, the secure PII transfer manager 920 may include a user input component 925, a transfer request component 930, an access link component 935, an access link forwarding component 940, a blockchain transfer component 945, an VASP identification component 950, or any combination thereof. Each of these components may communicate, directly or indirectly, with one another (e.g., via one or more buses, communications links, communications interfaces, or any combination thereof). The secure PII transfer manager 920 may be an example of or a component of a VASP, such as the first VASP 210-a as described with reference to FIGS. 3 and 4.

The secure PII transfer manager 920 may support secure exchange of PII (PII) in accordance with examples as disclosed herein. The user input component 925 may be configured as or otherwise support a means for receiving, based at least in part on a transfer of an amount of a crypto token from a first blockchain address of a first user and managed by a first VASP to a second blockchain address managed by a second VASP, a user input indicative of the second VASP and the second blockchain address. The transfer request component 930 may be configured as or otherwise support a means for transmitting, to a PII transmission service and after receiving the user input, a request to securely transfer PII of the first user of the first VASP with the second VASP. The access link component 935 may be configured as or otherwise support a means for receiving, from the PII transmission service, a link to access encrypted PII stored at a database of the PII transmission service and accessible by the second VASP. The access link forwarding component 940 may be configured as or otherwise support a means for transmitting the link to the second VASP.

In some examples, the transfer request component 930 may be configured as or otherwise support a means for transmitting, to the PII transmission service, a second request to securely receive second PII from a third VASP, wherein the request is received based at least in part on a second requested blockchain transfer of a second amount of a second crypto token to a third blockchain address managed by the first VASP and from a fourth blockchain address managed by the third VASP. In some examples, the access link component 935 may be configured as or otherwise support a means for receiving, from the PII transmission service, a second link to the PII transmission service and accessible by the third VASP to input the second PII. In some examples, the access link forwarding component 940 may be configured as or otherwise support a means for transmitting the second link to the third VASP.

In some examples, the blockchain transfer component 945 may be configured as or otherwise support a means for receiving an indication of the second requested blockchain transfer of the second amount of the second crypto token from the third blockchain address managed by the first VASP to the fourth blockchain address. In some examples, the VASP identification component 950 may be configured as or otherwise support a means for identifying the third VASP managing the fourth blockchain address, wherein the second request is transmitted based at least in part on identifying the third VASP.

In some examples, the requested blockchain transfer of the amount of the crypto token is executed via a blockchain network based at least in part on transmitting the link.

In some examples, the request to securely transfer the PII is based at least in part on a geographic region of the first user.

In some examples, the PII comprises information indicative of the first user that is an owner of the first blockchain address.

In some examples, to support transmitting the request to securely transfer the PII of the first user, the transfer request component 930 may be configured as or otherwise support a means for transmitting one or more API calls that invoke one or more functions at the PII transmission service configured to encrypt the PII, store the PII, transmit the link, or any combination thereof.

In some examples, the link is received based at least in part on the second VASP not being associated with the PII transmission service.

FIG. 10 shows a diagram of a system 1000 including a system 1005 that supports secure transfer of PII for VASPs in accordance with aspects of the present disclosure. The system 1005 may be an example of or include components of a system 805 as described herein. The system 1005 may include components for secure transfer of PII, including components for transmitting and receiving communications, such as a secure PII transfer manager 1020, an input information 1010, an output information 1015, a network interface 1025, at least one memory 1030, at least one processor 1035, and a storage 1040. Each of these components may communicate, directly or indirectly, with one another (e.g., via one or more buses, communications links, communications interfaces, or any combination thereof). The system 1005 may be an example of or a component of a VASP, such as the first VASP 210-a as described with reference to FIGS. 3 and 4.

The network interface 1025 may enable the system 1005 to exchange information (e.g., input information 1010, output information 1015, or both) with other systems or devices (not shown). For example, the network interface 1025 may enable the system 1005 to connect to a network (e.g., a network 135 as described herein). The network interface 1025 may include one or more wireless network interfaces, one or more wired network interfaces, or any combination thereof.

Memory 1030 may include RAM, ROM, or both. The memory 1030 may store computer-readable, computer-executable software including instructions that, when executed, cause at least one processor 1035 to perform various functions described herein, such as functions supporting secure transfer of PII for VASPs. In some cases, the memory 1030 may contain, among other things, a basic input/output system (BIOS), which may control basic hardware or software operation such as the interaction with peripheral components or devices. In some cases, the memory 1030 may be an example of aspects of one or more components of a custodial token platform 110 as described with reference to FIG. 1. The memory 1030 may be an example of a single memory or multiple memories. For example, the system 1005 may include one or more memories 1030.

The processor 1035 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1035 may be configured to execute computer-readable instructions stored in at least one memory 1030 to perform various functions (e.g., functions or tasks supporting secure transfer of PII for VASPs). Though a single processor 1035 is depicted in the example of FIG. 10, it is to be understood that the system 1005 may include any quantity of one or more of processors 1035 and that a group of processors 1035 may collectively perform one or more functions ascribed herein to a processor, such as the processor 1035. The processor 1035 may be an example of a single processor or multiple processors. For example, the system 1005 may include one or more processors 1035.

Storage 1040 may be configured to store data that is generated, processed, stored, or otherwise used by the system 1005. In some cases, the storage 1040 may include one or more HDDs, one or more SDDs, or both. In some examples, the storage 1040 may be an example of a single database, a distributed database, multiple distributed databases, a data store, a data lake, or an emergency backup database. In some examples, the storage 1040 may be an example of one or more components described with reference to FIG. 1.

The secure PII transfer manager 1020 may support secure exchange of PII (PII) in accordance with examples as disclosed herein. For example, the secure PII transfer manager 1020 may be configured as or otherwise support a means for receiving, based at least in part on a transfer of an amount of a crypto token from a first blockchain address of a first user and managed by a first VASP to a second blockchain address managed by a second VASP, a user input indicative of the second VASP and the second blockchain address. The secure PII transfer manager 1020 may be configured as or otherwise support a means for transmitting, to a PII transmission service and after receiving the user input, a request to securely transfer PII of the first user of the first VASP with the second VASP. The secure PII transfer manager 1020 may be configured as or otherwise support a means for receiving, from the PII transmission service, a link to access encrypted PII stored at a database of the PII transmission service and accessible by the second VASP. The secure PII transfer manager 1020 may be configured as or otherwise support a means for transmitting the link to the second VASP.

By including or configuring the secure PII transfer manager 1020 in accordance with examples as described herein, the system 1005 may support techniques for improved user experience related to secure transfer of PII and improved capabilities related to performing blockchain transactions with a blockchain address of a different PII transmission service.

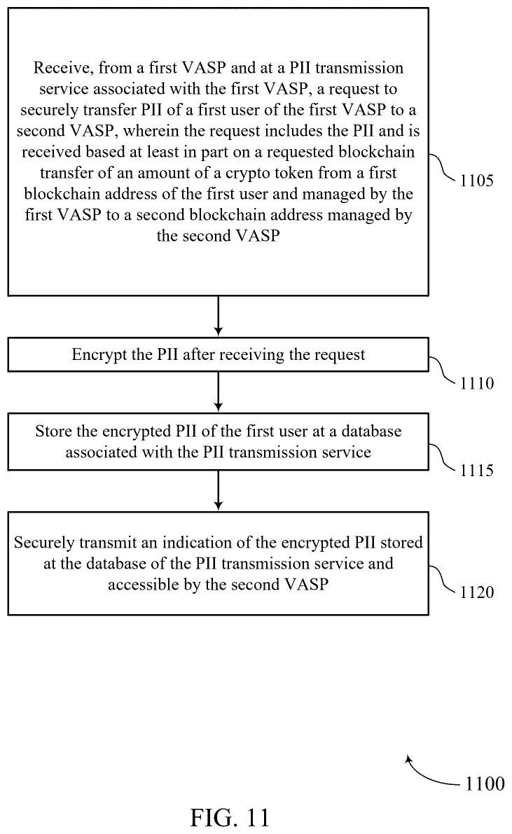

FIG. 11 shows a flowchart illustrating a method 1100 that supports secure transfer of PII for VASPs in accordance with aspects of the present disclosure. The operations of the method 1100 may be implemented by a PII transmission service or its components as described herein. For example, the operations of the method 1100 may be performed by a PII transmission service as described with reference to FIGS. 1 through 7. In some examples, a PII transmission service may execute a set of instructions to control the functional elements of the PII transmission service to perform the described functions. Additionally, or alternatively, the PII transmission service may perform aspects of the described functions using special-purpose hardware.

At 1105, the method may include receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP. The operations of 1105 may be performed in accordance with examples as disclosed herein. In some examples, aspects of the operations of 1105 may be performed by a transfer request component 625 as described with reference to FIG. 6.

At 1110, the method may include encrypting the PII after receiving the request. The operations of 1110 may be performed in accordance with examples as disclosed herein. In some examples, aspects of the operations of 1110 may be performed by an encryption component 630 as described with reference to FIG. 6.

At 1115, the method may include storing the encrypted PII of the first user at a database associated with the PII transmission service. The operations of 1115 may be performed in accordance with examples as disclosed herein. In some examples, aspects of the operations of 1115 may be performed by a storage component 635 as described with reference to FIG. 6.

At 1120, the method may include securely transmitting an indication of the encrypted PII stored at the database of the PII transmission service and accessible by the second VASP. The operations of 1120 may be performed in accordance with examples as disclosed herein. In some examples, aspects of the operations of 1120 may be performed by a secure transmission component 640 as described with reference to FIG. 6.

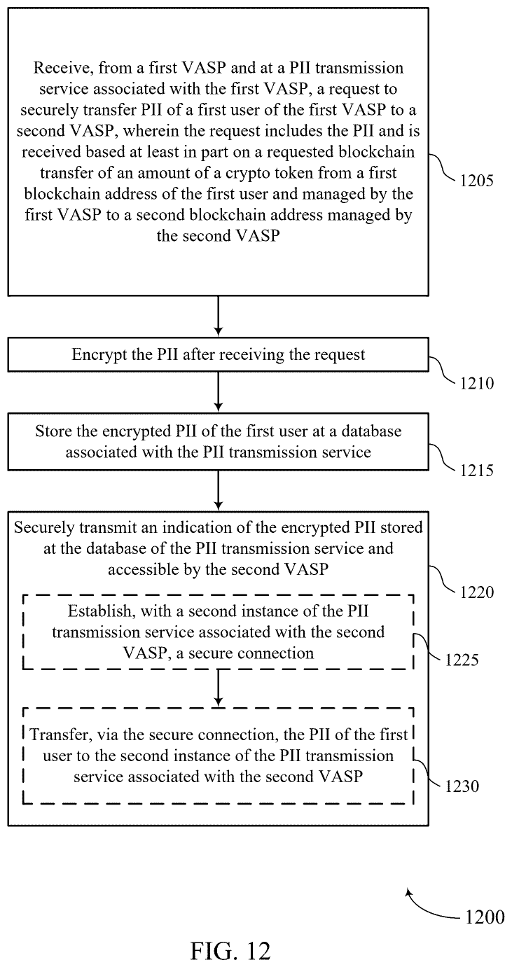

FIG. 12 shows a flowchart illustrating a method 1200 that supports secure transfer of PII for VASPs in accordance with aspects of the present disclosure. The operations of the method 1200 may be implemented by a PII transmission service or its components as described herein. For example, the operations of the method 1200 may be performed by a PII transmission service as described with reference to FIGS. 1 through 7. In some examples, a PII transmission service may execute a set of instructions to control the functional elements of the PII transmission service to perform the described functions. Additionally, or alternatively, the PII transmission service may perform aspects of the described functions using special-purpose hardware.

At 1205, the method may include receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP. The operations of 1205 may be performed in accordance with examples as disclosed herein. In some examples, aspects of the operations of 1205 may be performed by a transfer request component 625 as described with reference to FIG. 6.

At 1210, the method may include encrypting the PII after receiving the request. The operations of 1210 may be performed in accordance with examples as disclosed herein. In some examples, aspects of the operations of 1210 may be performed by an encryption component 630 as described with reference to FIG. 6.

At 1215, the method may include storing the encrypted PII of the first user at a database associated with the PII transmission service. The operations of 1215 may be performed in accordance with examples as disclosed herein. In some examples, aspects of the operations of 1215 may be performed by a storage component 635 as described with reference to FIG. 6.

At 1220, the method may include securely transmitting an indication of the encrypted PII stored at the database of the PII transmission service and accessible by the second VASP. The operations of 1220 may be performed in accordance with examples as disclosed herein. In some examples, aspects of the operations of 1220 may be performed by a secure transmission component 640 as described with reference to FIG. 6.

At 1225, securely transmitting the indication of the encrypted PII may include establishing, with a second instance of the PII transmission service associated with the second VASP, a secure connection. The operations of 1225 may be performed in accordance with examples as disclosed herein. In some examples, aspects of the operations of 1225 may be performed by a connection component 645 as described with reference to FIG. 6.

At 1230, securely transmitting the indication of the encrypted PII may include transferring, via the secure connection, the PII of the first user to the second instance of the PII transmission service associated with the second VASP. The operations of 1230 may be performed in accordance with examples as disclosed herein. In some examples, aspects of the operations of 1230 may be performed by a secure transmission component 640 as described with reference to FIG. 6.

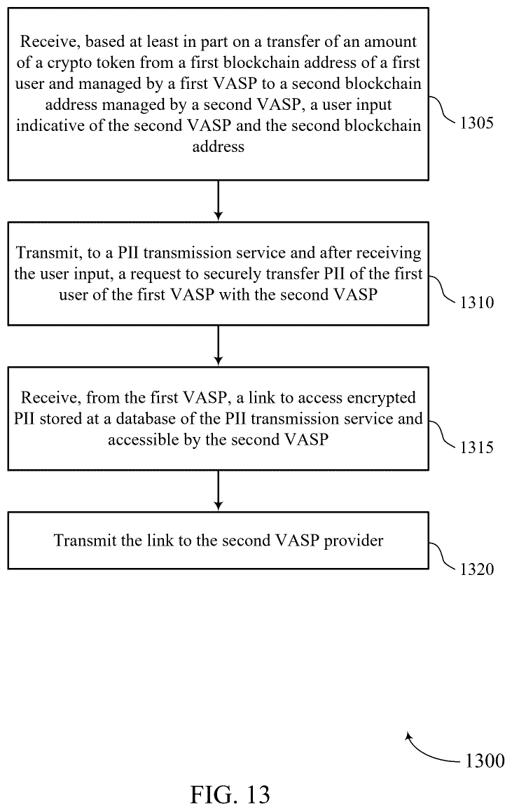

FIG. 13 shows a flowchart illustrating a method 1300 that supports secure transfer of PII for VASPs in accordance with aspects of the present disclosure. The operations of the method 1300 may be implemented by a VASP or its components as described herein. For example, the operations of the method 1300 may be performed by a VASP as described with reference to FIGS. 1 through 4 and 8 through 10. In some examples, a VASP may execute a set of instructions to control the functional elements of the VASP to perform the described functions. Additionally, or alternatively, the VASP may perform aspects of the described functions using special-purpose hardware.

At 1305, the method may include receiving, based at least in part on a transfer of an amount of a crypto token from a first blockchain address of a first user and managed by a first VASP to a second blockchain address managed by a second VASP, a user input indicative of the second VASP and the second blockchain address. The operations of 1305 may be performed in accordance with examples as disclosed herein. In some examples, aspects of the operations of 1305 may be performed by a user input component 925 as described with reference to FIG. 9.

At 1310, the method may include transmitting, to a PII transmission service and after receiving the user input, a request to securely transfer PII of the first user of the first VASP with the second VASP. The operations of 1310 may be performed in accordance with examples as disclosed herein. In some examples, aspects of the operations of 1310 may be performed by a transfer request component 930 as described with reference to FIG. 9.

At 1315, the method may include receiving, from the PII transmission service, a link to access encrypted PII stored at a database of the PII transmission service and accessible by the second VASP. The operations of 1315 may be performed in accordance with examples as disclosed herein. In some examples, aspects of the operations of 1315 may be performed by an access link component 935 as described with reference to FIG. 9.

At 1320, the method may include transmitting the link to the second VASP. The operations of 1320 may be performed in accordance with examples as disclosed herein. In some examples, aspects of the operations of 1320 may be performed by an access link forwarding component 940 as described with reference to FIG. 9.

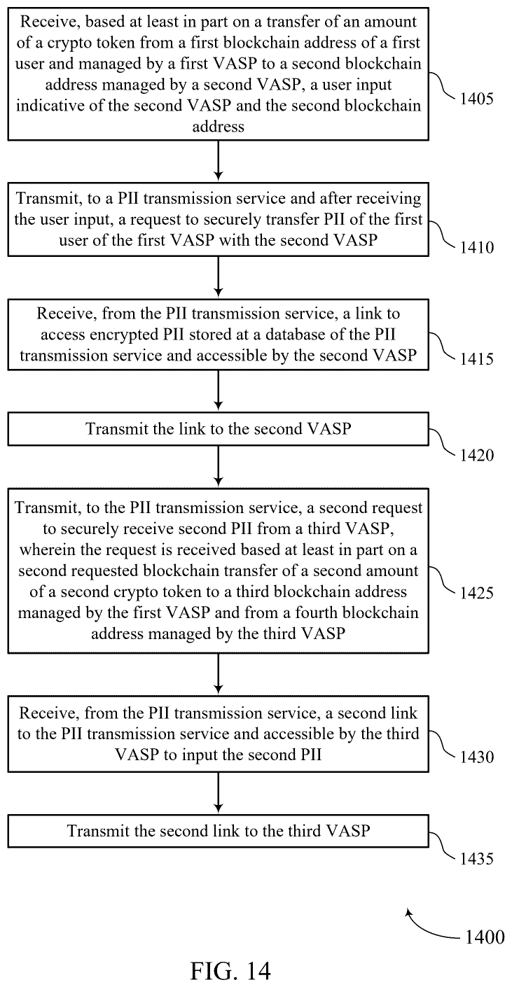

FIG. 14 shows a flowchart illustrating a method 1400 that supports secure transfer of PII for VASPs in accordance with aspects of the present disclosure. The operations of the method 1400 may be implemented by a VASP or its components as described herein. For example, the operations of the method 1400 may be performed by a VASP as described with reference to FIGS. 1 through 4 and 8 through 10. In some examples, a VASP may execute a set of instructions to control the functional elements of the VASP to perform the described functions. Additionally, or alternatively, the VASP may perform aspects of the described functions using special-purpose hardware.

At 1405, the method may include receiving, based at least in part on a transfer of an amount of a crypto token from a first blockchain address of a first user and managed by a first VASP to a second blockchain address managed by a second VASP, a user input indicative of the second VASP and the second blockchain address. The operations of 1405 may be performed in accordance with examples as disclosed herein. In some examples, aspects of the operations of 1405 may be performed by a user input component 925 as described with reference to FIG. 9.

At 1410, the method may include transmitting, to a PII transmission service and after receiving the user input, a request to securely transfer PII of the first user of the first VASP with the second VASP. The operations of 1410 may be performed in accordance with examples as disclosed herein. In some examples, aspects of the operations of 1410 may be performed by a transfer request component 930 as described with reference to FIG. 9.

At 1415, the method may include receiving, from the PII transmission service, a link to access encrypted PII stored at a database of the PII transmission service and accessible by the second VASP. The operations of 1415 may be performed in accordance with examples as disclosed herein. In some examples, aspects of the operations of 1415 may be performed by an access link component 935 as described with reference to FIG. 9.

At 1420, the method may include transmitting the link to the second VASP. The operations of 1420 may be performed in accordance with examples as disclosed herein. In some examples, aspects of the operations of 1420 may be performed by an access link forwarding component 940 as described with reference to FIG. 9.

At 1425, the method may include transmitting, to the PII transmission service, a second request to securely receive second PII from a third VASP, wherein the request is received based at least in part on a second requested blockchain transfer of a second amount of a second crypto token to a third blockchain address managed by the first VASP and from a fourth blockchain address managed by the third VASP. The operations of 1425 may be performed in accordance with examples as disclosed herein. In some examples, aspects of the operations of 1425 may be performed by a transfer request component 930 as described with reference to FIG. 9.

At 1430, the method may include receiving, from the PII transmission service, a second link to the PII transmission service and accessible by the third VASP to input the second PII. The operations of 1430 may be performed in accordance with examples as disclosed herein. In some examples, aspects of the operations of 1430 may be performed by an access link component 935 as described with reference to FIG. 9.

At 1435, the method may include transmitting the second link to the third VASP. The operations of 1435 may be performed in accordance with examples as disclosed herein. In some examples, aspects of the operations of 1435 may be performed by an access link forwarding component 940 as described with reference to FIG. 9.

A method for secure exchange of PII by an apparatus is described. The method may include receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP, encrypting the PII after receiving the request, storing the encrypted PII of the first user at a database associated with the PII transmission service, and securely transmitting an indication of the encrypted PII stored at the database of the PII transmission service and accessible by the second VASP.

An apparatus for secure exchange of PII is described. The apparatus may include one or more memories storing processor executable code, and one or more processors coupled with the one or more memories. The one or more processors may individually or collectively be operable to execute the code to cause the apparatus to receive, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP, encrypt the PII after receiving the request, store the encrypted PII of the first user at a database associated with the PII transmission service, and securely transmit an indication of the encrypted PII stored at the database of the PII transmission service and accessible by the second VASP.

Another apparatus for secure exchange of PII is described. The apparatus may include means for receiving, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP, means for encrypting the PII after receiving the request, means for storing the encrypted PII of the first user at a database associated with the PII transmission service, and means for securely transmitting an indication of the encrypted PII stored at the database of the PII transmission service and accessible by the second VASP.

A non-transitory computer-readable medium storing code for secure exchange of PII is described. The code may include instructions executable by one or more processors to receive, from a first VASP and at a PII transmission service associated with the first VASP, a request to securely transfer PII of a first user of the first VASP to a second VASP, wherein the request includes the PII and is received based at least in part on a requested blockchain transfer of an amount of a crypto token from a first blockchain address of the first user and managed by the first VASP to a second blockchain address managed by the second VASP, encrypt the PII after receiving the request, store the encrypted PII of the first user at a database associated with the PII transmission service, and securely transmit an indication of the encrypted PII stored at the database of the PII transmission service and accessible by the second VASP.

In some examples of the method, apparatus, and non-transitory computer-readable medium described herein, securely transmitting the indication of the encrypted PII may include operations, features, means, or instructions for establishing, with a second instance of the PII transmission service associated with the second VASP, a secure connection and transferring, via the secure connection, the PII of the first user to the second instance of the PII transmission service associated with the second VASP.

In some examples of the method, apparatus, and non-transitory computer-readable medium described herein, the secure connection may be established based at least in part on the first VASP and the second VASP being associated with the PII transmission service.

In some examples of the method, apparatus, and non-transitory computer-readable medium described herein, securely transmitting the indication of the encrypted PII may include operations, features, means, or instructions for transmitting, to the first VASP, a link to the encrypted PII stored at the database of the PII transmission service and accessible by the second VASP.

In some examples of the method, apparatus, and non-transitory computer-readable medium described herein, the link may be transmitted based at least in part on the second VASP not being associated with the PII transmission service.

Some examples of the method, apparatus, and non-transitory computer-readable medium described herein may further include operations, features, means, or instructions for receiving, from the first VASP and at the PII transmission service, a second request to securely receive second PII from a third VASP, wherein the request may be received based at least in part on a second requested blockchain transfer of a second amount of a second crypto token to a third blockchain address managed by the first VASP and from a fourth blockchain address managed by the third VASP and transmitting, to the first VASP, a second link to the PII transmission service and accessible by the third VASP to input the second PII.

Some examples of the method, apparatus, and non-transitory computer-readable medium described herein may further include operations, features, means, or instructions for receiving, after transmitting the second link, the second PII from the third VASP, encrypting the second PII from the third VASP after receiving the second PII via the second link, and storing the encrypted second PII from the third VASP at the database associated with the PII transmission service.

In some examples of the method, apparatus, and non-transitory computer-readable medium described herein, the requested blockchain transfer of the amount of the crypto token may be executed via a blockchain network based at least in part on securely transmitting the indication of the encrypted PII.

In some examples of the method, apparatus, and non-transitory computer-readable medium described herein, the request to securely transfer the PII may be based at least in part on a geographic region of the first user.

In some examples of the method, apparatus, and non-transitory computer-readable medium described herein, the PII comprises information indicative of the first user that may be an owner of the first blockchain address.

In some examples of the method, apparatus, and non-transitory computer-readable medium described herein, receiving the request to securely transfer the PII of the first user may include operations, features, means, or instructions for receiving, from the first VASP, one or more API calls that invoke one or more functions at the PII transmission service configured to encrypt the PII, store the PII, securely transmit the indication, or any combination thereof.

A method for secure exchange of PII by an apparatus is described. The method may include receiving, based at least in part on a transfer of an amount of a crypto token from a first blockchain address of a first user and managed by a first VASP to a second blockchain address managed by a second VASP, a user input indicative of the second VASP and the second blockchain address, transmitting, to a PII transmission service and after receiving the user input, a request to securely transfer PII of the first user of the first VASP with the second VASP, receiving, from the PII transmission service, a link to access encrypted PII stored at a database of the PII transmission service and accessible by the second VASP, and transmitting the link to the second VASP.

An apparatus for secure exchange of PII is described. The apparatus may include one or more memories storing processor executable code, and one or more processors coupled with the one or more memories. The one or more processors may individually or collectively be operable to execute the code to cause the apparatus to receive, based at least in part on a transfer of an amount of a crypto token from a first blockchain address of a first user and managed by a first VASP to a second blockchain address managed by a second VASP, a user input indicative of the second VASP and the second blockchain address, transmit, to a PII transmission service and after receiving the user input, a request to securely transfer PII of the first user of the first VASP with the second VASP, receive, from the PII transmission service, a link to access encrypted PII stored at a database of the PII transmission service and accessible by the second VASP, and transmit the link to the second VASP.

Another apparatus for secure exchange of PII is described. The apparatus may include means for receiving, based at least in part on a transfer of an amount of a crypto token from a first blockchain address of a first user and managed by a first VASP to a second blockchain address managed by a second VASP, a user input indicative of the second VASP and the second blockchain address, means for transmitting, to a PII transmission service and after receiving the user input, a request to securely transfer PII of the first user of the first VASP with the second VASP, means for receiving, from the PII transmission service, a link to access encrypted PII stored at a database of the PII transmission service and accessible by the second VASP, and means for transmitting the link to the second VASP.

A non-transitory computer-readable medium storing code for secure exchange of PII is described. The code may include instructions executable by one or more processors to receive, based at least in part on a transfer of an amount of a crypto token from a first blockchain address of a first user and managed by a first VASP to a second blockchain address managed by a second VASP, a user input indicative of the second VASP and the second blockchain address, transmit, to a PII transmission service and after receiving the user input, a request to securely transfer PII of the first user of the first VASP with the second VASP, receive, from the PII transmission service, a link to access encrypted PII stored at a database of the PII transmission service and accessible by the second VASP, and transmit the link to the second VASP.

Some examples of the method, apparatus, and non-transitory computer-readable medium described herein may further include operations, features, means, or instructions for transmitting, to the PII transmission service, a second request to securely receive second PII from a third VASP, wherein the request may be received based at least in part on a second requested blockchain transfer of a second amount of a second crypto token to a third blockchain address managed by the first VASP and from a fourth blockchain address managed by the third VASP, receiving, from the PII transmission service, a second link to the PII transmission service and accessible by the third VASP to input the second PII, and transmitting the second link to the third VASP.

Some examples of the method, apparatus, and non-transitory computer-readable medium described herein may further include operations, features, means, or instructions for receiving an indication of the second requested blockchain transfer of the second amount of the second crypto token from the third blockchain address managed by the first VASP to the fourth blockchain address and identifying the third VASP managing the fourth blockchain address, wherein the second request may be transmitted based at least in part on identifying the third VASP.

In some examples of the method, apparatus, and non-transitory computer-readable medium described herein, the requested blockchain transfer of the amount of the crypto token may be executed via a blockchain network based at least in part on transmitting the link.

In some examples of the method, apparatus, and non-transitory computer-readable medium described herein, the request to securely transfer the PII may be based at least in part on a geographic region of the first user.

In some examples of the method, apparatus, and non-transitory computer-readable medium described herein, the PII comprises information indicative of the first user that may be an owner of the first blockchain address.

In some examples of the method, apparatus, and non-transitory computer-readable medium described herein, transmitting the request to securely transfer the PII of the first user may include operations, features, means, or instructions for transmitting one or more API calls that invoke one or more functions at the PII transmission service configured to encrypt the PII, store the PII, transmit the link, or any combination thereof.

In some examples of the method, apparatus, and non-transitory computer-readable medium described herein, the link may be received based at least in part on the second VASP not being associated with the PII transmission service.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for secure exchange of personally identifiable information (PII), comprising:
receiving, from a first virtual asset service provider and at a PII transmission service associated with the first virtual asset service provider, a request to securely transfer PII of a first user of the first virtual asset service provider to a second virtual asset service provider, wherein the request includes the PII and is received based at least in part on a requested blockchain transfer of an amount of a crypto token from a first blockchain address of the first user and managed by the first virtual asset service provider to a second blockchain address managed by the second virtual asset service provider;
encrypting the PII after receiving the request;
storing the encrypted PII of the first user at a database associated with the PII transmission service; and
securely transmitting an indication of the encrypted PII stored at the database of the PII transmission service and accessible by the second virtual asset service provider.

2. The method of claim 1, wherein securely transmitting the indication of the encrypted PII comprises:
establishing, with a second instance of the PII transmission service associated with the second virtual asset service provider, a secure connection; and
transferring, via the secure connection, the PII of the first user to the second instance of the PII transmission service associated with the second virtual asset service provider.

3. The method of claim 2, wherein the secure connection is established based at least in part on the first virtual asset service provider and the second virtual asset service provider being associated with the PII transmission service.

4. The method of claim 1, wherein securely transmitting the indication of the encrypted PII comprises:
transmitting, to the first virtual asset service provider, a link to the encrypted PII stored at the database of the PII transmission service and accessible by the second virtual asset service provider.

5. The method of claim 4, wherein the link is transmitted based at least in part on the second virtual asset service provider not being associated with the PII transmission service.

6. The method of claim 1, further comprising:
receiving, from the first virtual asset service provider and at the PII transmission service, a second request to securely receive second PII from a third virtual asset service provider, wherein the request is received based at least in part on a second requested blockchain transfer of a second amount of a second crypto token to a third blockchain address managed by the first virtual asset service provider and from a fourth blockchain address managed by the third virtual asset service provider; and
transmitting, to the first virtual asset service provider, a second link to the PII transmission service and accessible by the third virtual asset service provider to input the second PII.

7. The method of claim 6, further comprising:
receiving, after transmitting the second link, the second PII from the third virtual asset service provider;
encrypting the second PII from the third virtual asset service provider after receiving the second PII via the second link; and
storing the encrypted second PII from the third virtual asset service provider at the database associated with the PII transmission service.

8. The method of claim 1, wherein the requested blockchain transfer of the amount of the crypto token is executed via a blockchain network based at least in part on securely transmitting the indication of the encrypted PII.

9. The method of claim 1, wherein the request to securely transfer the PII is based at least in part on a geographic region of the first user.

10. The method of claim 1, wherein the PII comprises information indicative of the first user that is an owner of the first blockchain address.

11. The method of claim 1, wherein receiving the request to securely transfer the PII of the first user comprises:
receiving, from the first virtual asset service provider, one or more application programming interface (API) calls that invoke one or more functions at the PII transmission service configured to encrypt the PII, store the PII, securely transmit the indication, or any combination thereof.

12. A method for secure exchange of personally identifiable information (PII), comprising:
receiving, based at least in part on a transfer of an amount of a crypto token from a first blockchain address of a first user and managed by a first virtual asset service provider to a second blockchain address managed by a second virtual asset service provider, a user input indicative of the second virtual asset service provider and the second blockchain address;
transmitting, to a PII transmission service and after receiving the user input, a request to securely transfer PII of the first user of the first virtual asset service provider with the second virtual asset service provider;
receiving, from the PII transmission service, a link to access encrypted PII stored at a database of the PII transmission service and accessible by the second virtual asset service provider; and
transmitting the link to the second virtual asset service provider.

13. The method of claim 12, further comprising:
transmitting, to the PII transmission service, a second request to securely receive second PII from a third virtual asset service provider, wherein the request is received based at least in part on a second requested blockchain transfer of a second amount of a second crypto token to a third blockchain address managed by the first virtual asset service provider and from a fourth blockchain address managed by the third virtual asset service provider;
receiving, from the PII transmission service, a second link to the PII transmission service and accessible by the third virtual asset service provider to input the second PII; and
transmitting the second link to the third virtual asset service provider.

14. The method of claim 13, further comprising:
receiving an indication of the second requested blockchain transfer of the second amount of the second crypto token from the third blockchain address managed by the first virtual asset service provider to the fourth blockchain address; and
identifying the third virtual asset service provider managing the fourth blockchain address, wherein the second request is transmitted based at least in part on identifying the third virtual asset service provider.

15. The method of claim 12, wherein the requested blockchain transfer of the amount of the crypto token is executed via a blockchain network based at least in part on transmitting the link.

16. The method of claim 12, wherein the request to securely transfer the PII is based at least in part on a geographic region of the first user.

17. The method of claim 12, wherein the PII comprises information indicative of the first user that is an owner of the first blockchain address.

18. The method of claim 12, wherein transmitting the request to securely transfer the PII of the first user comprises:
transmitting one or more application programming interface (API) calls that invoke one or more functions at the PII transmission service configured to encrypt the PII, store the PII, transmit the link, or any combination thereof.

19. The method of claim 12, wherein the link is received based at least in part on the second virtual asset service provider not being associated with the PII transmission service.

20. An apparatus for secure exchange of personally identifiable information (PII), comprising:
one or more memories storing processor-executable code; and
one or more processors coupled with the one or more memories and individually or collectively operable to execute the code to cause the apparatus to:
receive, from a first virtual asset service provider and at a PII transmission service associated with the first virtual asset service provider, a request to securely transfer PII of a first user of the first virtual asset service provider to a second virtual asset service provider, wherein the request includes the PII and is received based at least in part on a requested blockchain transfer of an amount of a crypto token from a first blockchain address of the first user and managed by the first virtual asset service provider to a second blockchain address managed by the second virtual asset service provider;
encrypt the PII after receiving the request;
store the encrypted PII of the first user at a database associated with the PII transmission service; and
transmitting, to the first virtual asset service provider, a link to the encrypted PII stored at the database of the PII transmission service and accessible by the second virtual asset service provider.
